(19) United States
(12) Patent Application Publication
(10) Pub. No.: US 2003/0205686 A1
(43) Pub. Date: Nov. 6, 2003

(54) Stop valve for water pipe

(76) Inventor: Jin-Yue Chiu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/135,569

(22) Filed: May 1, 2002

(51) Int. Cl. F16K 5/00

(52) U.S. Cl. 251/309

(57) ABSTRACT

A stop valve for water pipes includes a body, and a valve block. The body has a through hole extending from one end to other, and a cylindrical holding hole on one side to communicate with the through hole. The valve block has a transverse hole, and is disposed in the cylindrical holding hole so that water can flow through the through hole when the valve block is open where the transverse hole is aligned with the through hole of the body. In addition, the valve block is formed with a cylindrical shape so that it can be stably held in position by means of those portions of the body that define the cylindrical holding hole to secure a tight contact of the valve block with a leak-prevention ring equipped around one inner end of the through hole.

### BACKGROUND OF THE INVENTION

The present invention relates to a stop valve for water pipe, more particularly one, which is relatively easy to assemble, and is provided with such a structure that leakage is prevented.

Referring to FIG. 4, a conventional valve 2 has a body 21, a ball 3, and a control lever 4. The body 21 has threads 22 on an inner side of one end, and threads 23 on an outer side of the other end so that it can be connected to water pipes at two ends. The body 21 is provided with a connecting portion on one side; the connecting portion has a curved trench 29 on a top, and a connecting hole 28, which communicates with a holding room 24 inside the body 21. The body 21 further has an annular trench 26 formed between the threads 23 and the holding room 24. A leak-prevention ring 27 is fitted onto the annular trench 26.

The ball 3 is provided with a transverse passage 31, a circular protrusion 32, and a rectangular post 33 on top of the protrusion 32. The rectangular post 33 is formed with a screw hole 35. A leak-prevention ring 34 is provided around the circular protrusion 32.

The control lever 4 has a connecting portion 41 formed on a lower side of a handle portion. The connecting portion 41 has a rectangular hole 44, while the handle portion has a through hole 43 to be aligned with the hole 44. A stopped projection 45 is formed adjacent to the connecting portion 41.

The ball 3 is disposed in the holding room 24 of the body 21 with the post 33 being passed into the connecting hole 28, and with the spherical portion thereof coming into contact with the ring 27; the ring 34 comes into contact with the inner side of the connecting portion of the body 21 to prevent leakage. The control lever 4 is pivoted to the connecting hole 28 with the rectangular hole 44 being mounted around the rectangular post 33, and with the stopped projection 45 being confined in the curved trench 29; a screw 42 is screwed into the hole 43, and the screw hole 35 to join the lever 4 to the ball 3. Thus, the ball 3 can be moved by means of the lever 4 between an open position and a shut position for controlling the flow of liquid. And, the edges of the curved trench 29, and the stopped projection 45 help locate the ball 3 in the desired positions.

However, the valve is found to have disadvantages as followings:

1. Being suspended in the holding room 24, the ball 3 is prone to move to lose tight contact with the leak-prevention ring 27 due to change of direction of the liquid flowing through the pipes.

2. Being not supported at the sides while being only suspended in the holding room 24, the ball 3 can be easily shaken, and loses the tight contact with the ring 27 when the body 21 is moved.

3. Liquid is likely to leak through the joint between the connecting portion of the body 21 and the ring 34.

4. The valve is relatively difficult to assemble because the worker has to first pass the ball into the holding room with the rectangular post 33 being faced with the connecting hole 28 of the body 21, and then fits the lever onto the body 21 with the rectangular hole 44 being right passed onto the post 33. Consequently, the labor cost increases.

### SUMMARY OF THE INVENTION

It is a main object of the present invention to provide a stop valve for water pipes that is easy to assemble, and can prevent water from leaking.

The stop valve for water pipes of the present invention includes a body, a cylindrical valve block, and a control knob. The body has a through hole extending from one end to other, and a cylindrical holding hole on one side to communicate with the through hole. The valve block has a transverse hole, and is disposed in the cylindrical holding hole so that water can flow through the through hole of the body when the valve block is moved to an open position where the transverse hole is aligned with the through hole of the body. The control knob is disposed on top of the holding hole, and connected to a top of the valve block so that the valve block can be turned by means of operating the same.

Because the valve block is formed with a cylindrical shape, the same can be stably held in position by means of those portions of the body that defines the cylindrical holding hole to secure a tight contact of the valve block with a leak-prevention ring equipped around one inner end of the through hole of the body. Thus, water can't leak through the joint between the block and the ring when the valve block is moved to the shut position.

### BRIEF DESCRIPTION OF THE DRAWINGS

The present invention will be better understood by reference to the accompanying drawings, wherein:

FIG. 1 is an exploded perspective view of the stop valve of the present invention.

FIG. 2 is a cross-sectional view of the stop valve of the present invention in the open position.

FIG. 3 is a cross-sectional view of the stop valve of the present invention in the shut position.

FIG. 4 is an exploded perspective view of the prior stop valve.

FIG. 5 is a cross-sectional view of the prior stop valve in the open position.

FIG. 6 a cross-sectional view of the prior stop valve in the shut position.

### DTEAILED DESCRIPTION OF THE PREFERRED EMBODIMENTS

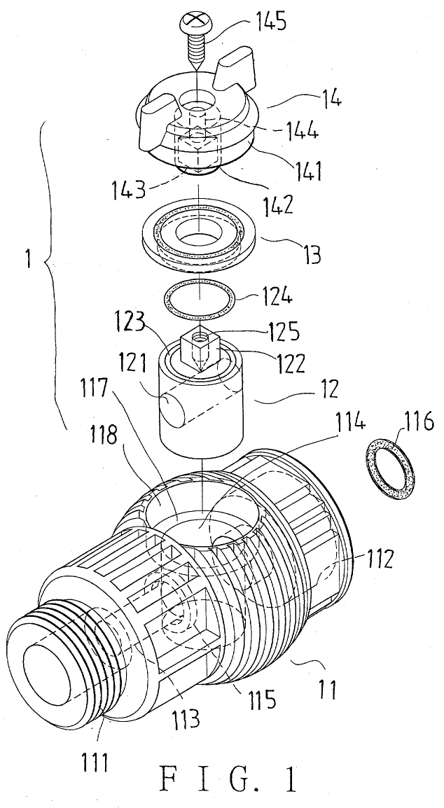

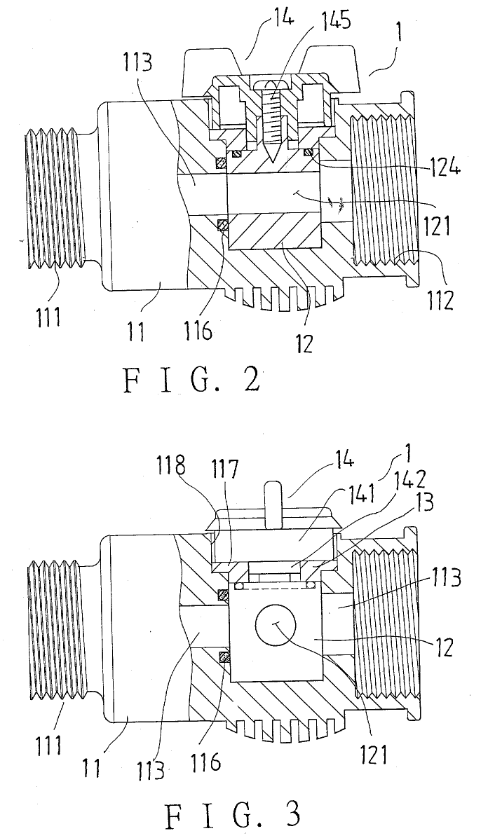

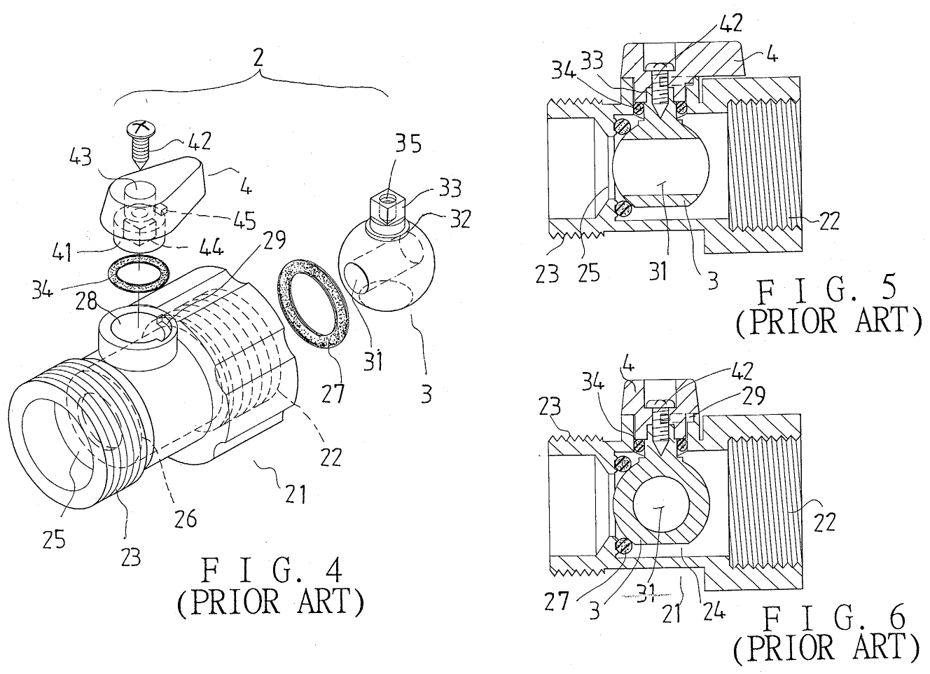

Referring to FIG. 1, a stop valve for water pipes of the present invention includes a body 11, a valve block 12, and a control knob 14.

The body 11 has threads 112 on an inner side of one end, and threads 111 on an outer side of the other end so that both ends can be screwed into, and onto threaded ends of water pipes respectively. The body 11 is provided with a cylindrical holding hole 114 on one lateral side, and a through hole 113, which extends from one end to the other end to communicate with the holding hole 114; thus, the through hole 113 is divided into two sections by the holding hole 114. An annual trench 115 is formed around one of two inner ends of the through hole 113, and a leak-prevention ring 116 is fitted to the annular trench 1 5. In addition, the holding hole 114 is provided with an enlarged portion 118 at an upper end portion thereof so that an annular supporting platform 117 is formed between the upper enlarged portion 118 and the lower smaller portion of the hole 114.

The valve block 12 is provided with a cylindrical shape, and has a transverse passage 121 extending along a diameter thereof. The valve block 12 is provided with an annular trench 123, a rectangular post 122 on a top end; a second leak-prevention ring 124 is secured to the annular trench 123. A screw hole 125 is formed on the rectangular post 122. The valve block 12 is tumably disposed in the cylindrical holding hole 114 with the rectangular post 122 being disposed within the upper enlarged portion 118. The cylindrical shape of both the holding hole 114 and the valve block 12 allows the valve block to be stably held in position by means of those portions of the body 11 that define the holding hole 114, i.e. both the bottom and the lateral wall around the holding hole 114, to secure a tight contact of the valve block 12 with the leak-prevention ring 116. A round cover 13 having a central hole (not numbered) is fitted into the upper enlarged portion 118 of the holding hole 114 with the central hole being passed around the rectangular post 122 of the block 12. The round cover 13 is fixedly connected to the supporting platform 117 in a watertight manner, and abuts the ring 124 in such a manner that water can't leak through the joint therebetween.

The control knob 14 is formed with a circular projection 14, and a connecting portion 142 on a lower side; the connecting portion 142 has a rectangular hole 143. A through hole 144 extends from the upper side of the control knob 14 and the circular projection 14 to communicate with the connecting portiopn 142. The control knob 14 is disposed on a top of the holding hole 114 of the body 11, and is connected to the valve block 13 with the rectangular hole 143 being passed around the rectangular post 122, and with a screw 145 being screwed into both the through hole 144 and the screw hole 125. Thus, the valve block 12 can, by means of operating the control knob 14, be turned between a shut position where the transverse passage 121 of the valve block 12 communicates with the through hole 113 of the body 13 and an open one where the through hole 113 is blocked by the valve block 12 for controlling the flow of water in the pipes connected to the body 11.

From the above description, it can be easily understood that the stop valve of the present invention has advantages as followings:

1. Having the same shape as the cylindrical holding hole 114 of the body 11, the valve block 12 can be stably supported by means of the bottom and the lateral defining wall of the holding hole 114; thus, the valve block 12 can't possibly lose the tight contact with the ring 116 even when the direction of water in the pipe is changed or the body is shaken.

2. The round cover 13 is fixedly connected to the body 11 to prevent the valve block 12 from losing the contact with the bottom of the holding hole 114.

3. Being fixedly connected to the body 11, and abutting the leak-prevention ring 124 disposed on top of the valve block 12 to prevent water from leaking, the round cover 13 provides an improved leak-preventing function as compared with the corresponding ring of the prior stop valve in the Background.

4. The stop valve is relatively easy to assemble when compared to the prior one because the valve block 12 can be easily and right put into tho holding hole 114, and no manual adjustment of position of the valve block is needed when the control knob 14 is being connected to the block 12.

What is claimed is:

1. A stop valve for water pipes, comprising
a body having a through hole extending from one end to other; the body having a cylindrical holding hole on one side to communicate with the through hole;
a valve block having a transverse hole; the valve block being tumably disposed in the cylindrical holding hole so that the same can be moved to an open position where the transverse hole is aligned with the through hole of the body for allowing water to flow through the through hole of the body;
a control knob; the control knob being disposed on top of the holding hole, and connected to a top of the valve block so that the valve block can be turned by means of operating the same;
and being characterized by:
a cylindrical shape being provided to the valve block for allowing the valve block to be held in position by means of both a bottom and a lateral wall of the cylindrical holding hole to secure a tight contact of the valve block with a first leak-prevention ring equipped around one inner end of the through hole of the body.

2. The stop valve of claim 1, wherein a round member, and a second leak-prevention ring are provided; the round member being disposed between the top of the valve block and the control knob, and fixedly connected to the side of the holding hole; the second ring being fitted onto an annual trench formed on the top of the valve block to form a watertight contact with the round member.
